(19) United States
(12) Patent Application Publication
(10) Pub. No.: US 2011/0074126 A1
(43) Pub. Date: Mar. 31, 2011

(54) Height Adjustment Device for Golf Push / Pull Carts

(76) Inventor: Jonathan Hwan Wang, Hayward, CA (US)

(21) Appl. No.: 12/790,824

(22) Filed: May 29, 2010

(30) Foreign Application Priority Data
Sep. 29, 2009 (CN) 200920236583.2

(51) Int. Cl. B62B 3/02

(52) U.S. Cl. 280/47.371

(57) ABSTRACT

This practical new technology involves a golf cart, golf carts, particularly related to the height adjustment device, which includes the base, which connects to the main bar of the golf cart, and slide block which connects to the handle of the golf cart. There are two parallel arc oriented plate formed on each side of the base, and sliding block on both sides of the location near the opening matching with the corresponding slide guide plate. Movement of the sliding block along the base of the curved guide plate adjusts the angle and position between the sliding block and base. Furthermore, the movement can adjust the angle and position of the handle and the main bar and the overall height of the structure. The utility model is simple, suitable for different groups of people, according to needs and to adjust handle height at anytime; low cost and long life.

### BACKGROUND OF THE INVENTION

Golf carts are known to be pushed/pulled during walking; the position of the handle is fixed in the frame and cannot be changed, which will bring the following issues: such as the difference in pushing/pulling a cart when walking on level ground, walking uphill, and walking downhill; or having users of different heights use the golf cart. For each state, the height between the handle and the person is different, so if users cannot adjust the height of the handle, then it will cause inconvenience for the user. If the location of a golf cart handle height can be adjusted, it will give users more convenience.

### BRIEF SUMMARY OF THE INVENTION

This practical new technology involves a golf cart, golf carts, particularly involves a height adjustment device, which includes the base, which connects to the main bar of the golf cart, and slide block which connects to the handle of the golf cart. The purpose of this utility model is for the shortcomings of existing technology to provide a height adjustment device between the handle and main frame of the golf cart, so that the location of the handle can be height adjustable; an easy to use golf cart height adjustment device. There are two parallel arc oriented plate formed on each side of the base, and sliding block on both sides of the location near the opening matching with the corresponding slide guide plate, the two guide plates are put in the two slide chutes, the promotion of sliding block along the base of the curved guide plate sliding, can adjust the angle and position between the sliding block and base. Furthermore, the movement can adjust the angle and position of the handle and the main bar and the overall height of the structure. The utility model is simple, suitable for different groups of people to use, according to needs and to adjust handle height at anytime; low cost and long life.

### BRIEF DESCRIPTION OF THE DRAWINGS

FIG. 1 is a schematic diagram of the structure of a utility model;

FIG. 2 is another perspective of the utility model structure diagram;

FIG. 3 is a schematic diagram of the utility model of decomposition.

### DETAILED DESCRIPTION OF THE INVENTION

The purpose of this utility model is for the shortcomings of existing technology to provide a height adjustment device between the handle and main frame of the golf cart, so that the location of the handle can be height adjustable; an easy to use golf cart height adjustment device. To achieve this purpose, the utility of new technologies used are:

Golf cart height adjustment device, which includes a rod connected which includes the base, which connects to the main bar of the golf cart, and slide block which connects to the handle of the golf cart. There are two parallel arc oriented plate formed on each side of the base, and sliding block on both sides of the location near the opening matching with the corresponding slide guide plate, the two guide plates are put in the two slide chutes.

As described, on the outside of the guide plate is a curved guide slot on each side, the chute on the sliding block has a convex card block, which is located on the inner wall of the chute that slides on the curved guide slot, which corresponds with the convex card block, the card block sits within the curved guide slot.

As described, the bottom of the base has an open plug-in slot.

As described, the sliding block has a vertical mounting hole.

As described, in between sliding block and base has a lock tight locking block, which can lock on to the base. The locking block and the sliding block has a sliding connection, on both sides of the bottom of the locking block has a card column; on the inside top of the guide plate has several concave slots which can fit the card column.

As described, the junction of the sliding block and the locking block has a vertical rail sliding slot. The locking block is equipped with a guide bar that fits through the vertical rail sliding slot.

As described, the junction of the sliding block and the locking block has a vertical chamber. The vertical chamber has screw and spring; the threaded end of the screw goes through the vertical chamber and is fixed to the locking block. The spring sits between the top of the screw and vertical chamber.

The beneficial effects of a utility model is: this practical new technology involves a golf cart, golf carts, particularly related to the height adjustment device, which includes the base, which connects to the main bar of the golf cart, and slide block which connects to the handle of the golf cart. There are two parallel arc oriented plate formed on each side of the base, and sliding block on both sides of the location near the opening matching with the corresponding slide guide plate, the two guide plates are put in the two slide chutes, the promotion of sliding the sliding block along the base of the curved guide plate can adjust the angle and position between the sliding block and base. Furthermore, the movement can adjust the angle and position of the handle and the main bar and the overall height of the structure. The utility model is simple, suitable for different groups of people to use, according to needs and to adjust handle height at anytime; low cost and long life.

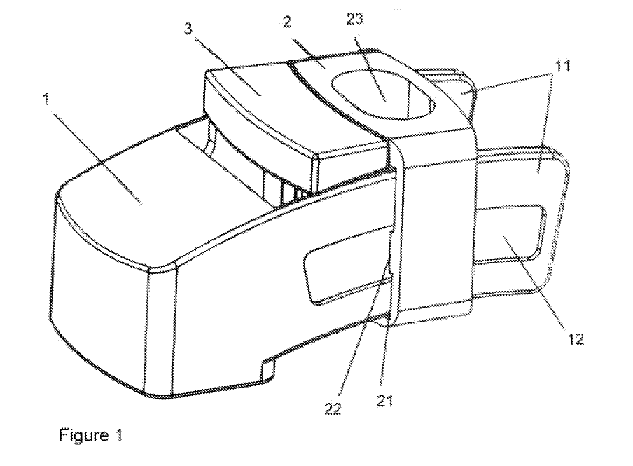

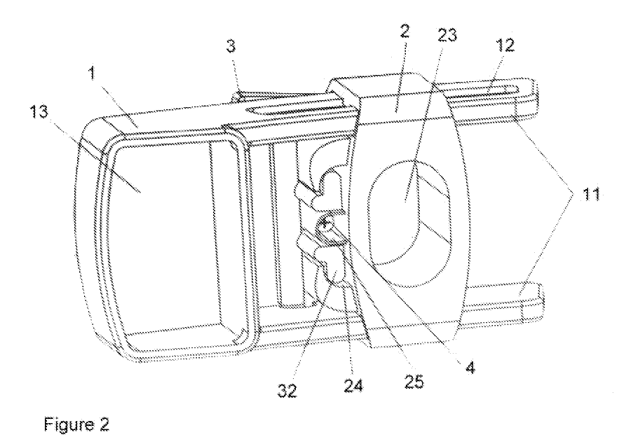

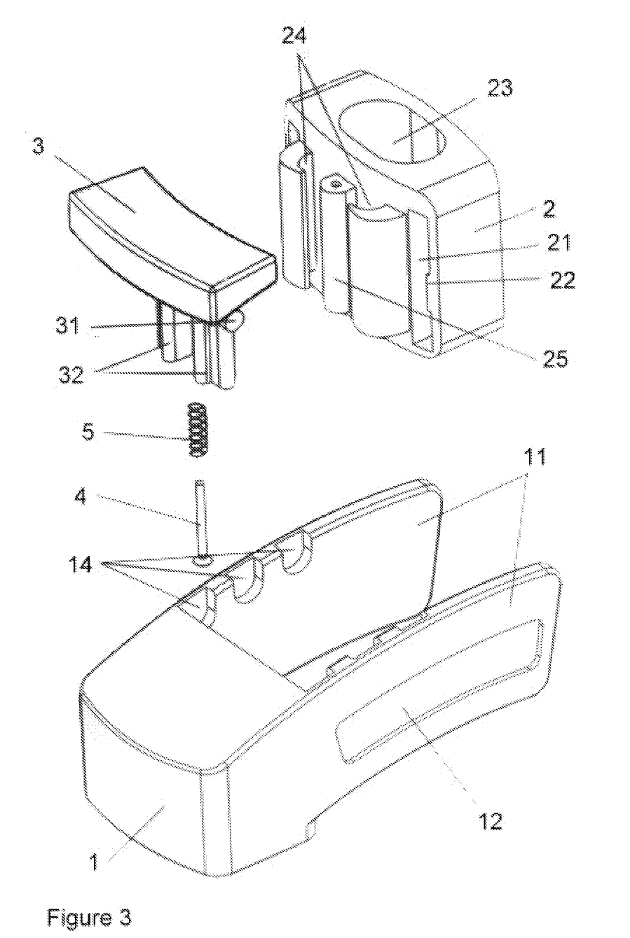

The following photos of the utility model combined with further instructions, as shown in FIGS. 1 to 3, the height adjustment device golf cart, which includes a rod connected with the base of the main frame (1), with the handle connected to slide block (2), the bottom of the base (1) has an open plug-in slot (13) installed, the top of the main bar is fixed to the open plug-in slot (13); sliding block (2) has a vertical mounting hole (23) that fixes the bottom of the handle.

On the base (1) there are two parallel curved guide plates (11), sliding block (2) close to the location of the sides there is an opening for two guide plates (11) that correspond to matching the chute (21), two guide plates (11) are in sliding into the chute (21). The sliding block (2) can slide along within the curved guide slot (12) of the base (1).

Among them, the outside of the two lateral guide plates (11) has a curved guide slot (12) on each side, the chute (21) on the sliding block (2) has a convex card block (22), which is located on the inner wall of the chute (21) that slides on the curved guide slot (12), which corresponds with the convex card block (22), the convex card block (22) sits within the curved guide slot (12). The matching of the curved guide slot (12) and the corresponding card block (22) creates the sliding function, to make the sliding of the sliding block (2) more stable, and the curved guide slot limits the range of sliding the sliding block (2), to prevent the sliding block (2) to slide off of the guide plate (11).

In between the sliding block (2) and the base (1) has a lock tight locking block (3), which can lock the sliding block (2) on to the base (1). The locking block (3) and the sliding block (2) has a sliding connection, on both sides of the bottom of the locking block (3) has a card column (31); on the inside top of the guide plate (11) has several concave slots (14) which can fit the card column (31).

Several concave slots (14), which are distributed along the guide plate (11), form many stopping positions so the card column (31) can stop in any one of these concave slots (14). Based upon the demand of different heights, the card column (31) can stop on the appropriate concave slot (14).

The junction of the sliding block (2) and the locking block (3) has a vertical rail sliding slot (24). The locking block (3) is equipped with a guide bar (32) that fits through the vertical rail sliding slot (24). The locking block (3) is equipped with a guide bar (32) that fits through the vertical rail sliding slot (24).

The locking block (3) can vertically slide along with the sliding block (2). The junction of sliding block (2) and the locking block (3) is at vertical chamber (25). The vertical chamber (25) has screw (4) and spring (5); the threaded end of the screw (4) goes through the vertical chamber (25) and is fixed to the locking block (3). The spring (5) sits between the top of the screw and vertical chamber (25). When you need to adjust the height, first pull up the locking block (3), which triggers the deformation of the spring (5) and creates elastic tension. Then, slide the sliding block (2) to the desired position on the concave slot (14), and finally release locking block (3), and the elastic spring (5) slides back down; the card column (31) on the locking block (3) moves into the concave slot (14). Furthermore, the locking block (3) and sliding block (2) are fixed on to the base (1).

The utility model to promote the sliding of sliding block (2) along the base (1) of the curved guide plate (11), can adjust the angle and position between the sliding block (2) and base (1). Furthermore, the movement can adjust the angle and position of the handle and the main bar and the overall height of the structure. It is simple, suitable for different groups of people to use, according to needs and to adjust handle height at anytime; low cost and long life.

Of course, the above is just a sample case of the implementation of this utility model, so any area under this utility model patent application as described in the structure, characteristics and principle of equivalent changes or modifications made are included in the utility model patent application range.

1. A golf cart height adjustment device, characterized in that: it includes the base (1), which connects to the main bar of the golf cart, and the slide block (2) which connects to the handle. On the base (1) there are two parallel curved guide plates (11), sliding block (2) close to the location of the sides there is an opening for two guide plates (11) that correspond to matching the chute (21), two guide plates (11) are in sliding into the chute (21).

2. According to claim #1 golf cart height adjusting device, its characteristics: located on the outside of the guide plate (11) is a curved guide slot (12) on each side, the chute (21) on the sliding block (2) has a convex card block (22), which is located on the inner wall of the chute (21) that slides on the curved guide slot (12), which corresponds with the convex card block (22), the convex card block (22) sits within the curved guide slot (12).

3. According to claim #1 of the golf cart's height adjustment device, characterized in that: the bottom of the base (1) has an open plug-in slot (13).

4. According to claim #1 of the golf cart's height adjustment device, characterized in that: the sliding block (2) has a vertical mounting hole (23).

5. According to any of claims #1-#4, described in a golf cart to a height adjustment device, characterized in that: in between described sliding block (2) and base (1) has a lock tight locking block (3), which can lock on to the base (1). The locking block (3) and the sliding block (2) has a sliding connection, on both sides of the bottom of the locking block (3) has a card column (31); on the inside top of the guide plate (11) has several concave slots (14) which can fit the card column (31).

6. As described in claim #5, golf cart height adjustment device, characterized in that: the junction of the described sliding block (2) and the locking block (3) has a vertical rail sliding slot (24). The locking block (3) is equipped with a guide bar (32) that fits through the vertical rail sliding slot (24).

7. As described in claim #6, a golf cart height adjustment device, characterized in that: the junction of the described sliding block (2) and the locking block (3) has a vertical chamber (25). The vertical chamber (25) has screw (4) and spring (5); the threaded end of the screw (4) goes through the vertical chamber (25) and is fixed to the locking block (3). The spring (5) sits between the top of the screw and vertical chamber (25).
